(19) United States
(12) Patent Application Publication
(10) Pub. No.: US 2025/0300887 A1
(43) Pub. Date: Sep. 25, 2025

(54) METHOD, APPARATUS AND COMPUTER PROGRAM

(71) Applicant: Nokia Technologies Oy, Espoo (FI)

(72) Inventors: Stephen MWANJE, Munich (DE); Rakshesh PRAVINCHANDRA BHATT, Bangalore (IN); Sreevivek G N, Bangalore (IN); Shu Qiang SUN, Chengdu (CN)

(21) Appl. No.: 18/861,738

(22) PCT Filed: May 5, 2022
(86) PCT No.: PCT/CN2022/090874

§ 371 Date: Oct. 30, 2024

(51) Int. Cl. H04L 41/0833; H04L 41/149; H04W 52/02

(52) U.S. Cl. CPC H04L 41/0833; H04L 41/149; H04W 52/0206

(57) ABSTRACT

There is provided an apparatus comprising means for: receiving, from a management system, information indicating one or more priority values associated with a respective one or more cells; and performing one or more network optimization processes based on the received information indicating the one or more priority values associated with the respective one or more cells.

### FIELD

The present application relates to a method, apparatus, and computer program and in particular but not exclusively to performing a network optimization process based on priority values associated with one or more cells.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

### SUMMARY

According to an aspect, there is provided an apparatus comprising means for: receiving, from a management system, information indicating one or more priority values associated with a respective one or more cells; and performing one or more network optimization processes based on the received information indicating the one or more priority values associated with the respective one or more cells.

The one or more network optimization processes may comprise at least one of: determining a workflow sequence optimization; determining an opportunity window for a maintenance activity associated with the one or more cells; determining a self-optimizing network exclusion list; and determining a list of cells to be scheduled to operate with reduced energy requirement.

The performing may comprise: receiving, from the management system, a request for a workflow sequence based on the one or more priority values associated with the respective one or more cells; determining the workflow sequence based on the request and the information indicating the one or more priority values; and sending, to the management system, the determined workflow sequence.

The performing may comprise: determining at least one cell to be included in the self-optimizing network exclusion list based on the information indicating the one or more priority values; and sending, to the management system, the self-optimizing network exclusion list, wherein the exclusion list comprises the determined at least one cell.

The determining may comprise: determining, for each cell of the one or more cells, a respective priority value; comparing the determined priority value against a threshold; and including the cell in the self-optimizing network exclusion list if the comparison indicates that the priority value associated with the cell is above the threshold.

The performing may comprise: determining the list of cells for energy saving scheduling based on the information indicating the one or more priority values; and sending, to the management system, the determined list of cells for energy saving scheduling.

The determining may comprise: determining, for each cell of the one or more cells, a respective priority value; comparing the determined priority value against a threshold; and including the cell in the list of cells for energy saving scheduling if the comparison indicates that the priority value is below the threshold.

The performing may comprise: receiving, from the management system, a request for an opportunity window for a maintenance activity associated with the one or more cells; determining the opportunity window for the maintenance activity associated with the one or more cells based on the information indicating the one or more priority values; and at the start of the determined opportunity window, sending, to the management system, a notification for causing the maintenance activity to be performed.

According to an aspect, there is provided an apparatus comprising means for: receiving, from an automation function, information indicating one or more priority values associated with a respective one or more cells; and sending, to a network optimization function, the information indicating the one or more priority values associated with the respective one or more cells.

The means may be for: sending, to the network optimization function, a request for a workflow sequence based on the one or more priority values associated with the respective one or more cells; receiving, from the network optimization function, the workflow sequence; and causing one or more operations to be performed based on the received workflow sequence.

The means may be for: receiving, from the network optimization function, a self-optimizing network exclusion list, wherein the exclusion list comprises at least one of the one or more cells; and causing one or more self-optimizing network operations to be performed for cells other than the cells included in the self-optimizing network exclusion list.

The means may be for: receiving, from the network optimization function, a list of cells to be scheduled to operate with reduced energy requirement; and causing cells included in the list of cells to operate with reduced energy requirement.

The means may be for: receiving information indicating that a maintenance activity is required for the one or more cells; responsive to receiving the information indicating that the maintenance activity is required for the one or more cells, sending, to the network optimization function, a request for an opportunity window for performing the maintenance activity associated with the one or more cells; at the start of the opportunity window, receiving, from the network optimization function, a notification for causing the maintenance activity to be performed; and causing the maintenance activity to be performed in response to receiving the notification.

According to an aspect, there is provided an apparatus comprising means for: receiving an input comprising information indicating a strategy for cell prioritization for one or more cells; determining a priority value for each of the one or more cells based on the defined strategy; and sending, to a management system, information indicating the determined priority values associated with the one or more cells.

The means may be for: periodically performing the determining and the sending, wherein the received input further comprises information indicating a periodicity for performing the determining and the sending; and/or performing the determining and the sending in response to detecting a trigger event.

The means may be for: obtaining, from an analytics function and based on the information indicating the strategy for cell prioritization, analytics information associated with the one or more cells.

The analytics information associated with the one or more cells may comprise one or more of: predicted traffic information for the one or more cells; and predicted revenue information associated with the one or more cells.

The information indicating the one or more priority values may define a relative priority of the one or more cells.

The information indicating the one or more priority values may comprise a cell operational priority index.

The cell operational priority index may comprise a first set of bits indicating a strategy for cell prioritization and a second set of bits indicating a priority value; or the cell operational priority index may be a tuple of two values, wherein a first value indicates the strategy for cell prioritization and a second value indicates a priority value.

According to an aspect, there is provided an apparatus comprising at least one processor and at least one memory including a computer program code, the at least one memory and computer program code configured to, with the at least one processor, cause the apparatus at least to: receive, from a management system, information indicating one or more priority values associated with a respective one or more cells; and perform one or more network optimization processes based on the received information indicating the one or more priority values associated with the respective one or more cells.

The at least one memory and at least one processor may be configured to cause the apparatus to: determine a workflow sequence optimization; determine an opportunity window for a maintenance activity associated with the one or more cells; determine a self-optimizing network exclusion list; and determine a list of cells to be scheduled to operate with reduced energy requirement.

The at least one memory and at least one processor may be configured to cause the apparatus to: receive, from the management system, a request for a workflow sequence based on the one or more priority values associated with the respective one or more cells; determine the workflow sequence based on the request and the information indicating the one or more priority values; and send, to the management system, the determined workflow sequence.

The at least one memory and at least one processor may be configured to cause the apparatus to: determine at least one cell to be included in the self-optimizing network exclusion list based on the information indicating the one or more priority values; and send, to the management system, the self-optimizing network exclusion list, wherein the exclusion list comprises the determined at least one cell.

The at least one memory and at least one processor may be configured to cause the apparatus to: determine, for each cell of the one or more cells, a respective priority value; compare the determined priority value against a threshold; and include the cell in the self-optimizing network exclusion list if the comparison indicates that the priority value associated with the cell is above the threshold.

The at least one memory and at least one processor may be configured to cause the apparatus to: determine the list of cells for energy saving scheduling based on the information indicating the one or more priority values; and send, to the management system, the determined list of cells for energy saving scheduling.

The at least one memory and at least one processor may be configured to cause the apparatus to: determine, for each cell of the one or more cells, a respective priority value; compare the determined priority value against a threshold; and include the cell in the list of cells for energy saving scheduling if the comparison indicates that the priority value is below the threshold.

The at least one memory and at least one processor may be configured to cause the apparatus to: receive, from the management system, a request for an opportunity window for a maintenance activity associated with the one or more cells; determine the opportunity window for the maintenance activity associated with the one or more cells based on the information indicating the one or more priority values; and at the start of the determined opportunity window, send, to the management system, a notification for causing the maintenance activity to be performed.

According to an aspect, there is provided an apparatus comprising at least one processor and at least one memory including a computer program code, the at least one memory and computer program code configured to, with the at least one processor, cause the apparatus at least to: receiving, from an automation function, information indicating one or more priority values associated with a respective one or more cells; and sending, to a network optimization function, the information indicating the one or more priority values associated with the respective one or more cells.

The at least one memory and at least one processor may be configured to cause the apparatus to: send, to the network optimization function, a request for a workflow sequence based on the one or more priority values associated with the respective one or more cells; receive, from the network optimization function, the workflow sequence; and cause one or more operations to be performed based on the received workflow sequence.

The at least one memory and at least one processor may be configured to cause the apparatus to: receive from the network optimization function, a self-optimizing network exclusion list, wherein the exclusion list comprises at least one of the one or more cells; and cause one or more self-optimizing network operations to be performed for cells other than the cells included in the self-optimizing network exclusion list.

The at least one memory and at least one processor may be configured to cause the apparatus to: receive, from the network optimization function, a list of cells to be scheduled to operate with reduced energy requirement; and cause cells included in the list of cells to operate with reduced energy requirement.

The at least one memory and at least one processor may be configured to cause the apparatus to: receive information indicating that a maintenance activity is required for the one or more cells; responsive to receiving the information indicating that the maintenance activity is required for the one or more cells, send, to the network optimization function, a request for an opportunity window for performing the maintenance activity associated with the one or more cells; at the start of the opportunity window, receive, from the network optimization function, a notification for causing the maintenance activity to be performed; and cause the maintenance activity to be performed in response to receiving the notification.

According to an aspect, there is provided an apparatus comprising at least one processor and at least one memory including a computer program code, the at least one memory and computer program code configured to, with the at least one processor, cause the apparatus at least to: receive an input comprising information indicating a strategy for cell prioritization for one or more cells; determine a priority value for each of the one or more cells based on the defined strategy; and send, to a management system, information indicating the determined priority values associated with the one or more cells.

The at least one memory and at least one processor may be configured to cause the apparatus to: periodically determine the priority value and send the information, wherein the received input further comprises information indicating a periodicity for performing the determining and the sending; and/or determine the priority value and the send the information in response to detecting a trigger event.

The at least one memory and at least one processor may be configured to cause the apparatus to: obtain, from an analytics function and based on the information indicating the strategy for cell prioritization, analytics information associated with the one or more cells.

The analytics information associated with the one or more cells may comprise one or more of: predicted traffic information for the one or more cells; and predicted revenue information associated with the one or more cells.

The information indicating the one or more priority values may define a relative priority of the one or more cells.

The information indicating the one or more priority values may comprise a cell operational priority index.

The cell operational priority index may comprise a first set of bits indicating a strategy for cell prioritization and a second set of bits indicating a priority value; or the cell operational priority index may be a tuple of two values, wherein a first value indicates the strategy for cell prioritization and a second value indicates a priority value.

According to an aspect, there is provided a method comprising: receiving, from a management system, information indicating one or more priority values associated with a respective one or more cells; and performing one or more network optimization processes based on the received information indicating the one or more priority values associated with the respective one or more cells.

The one or more network optimization processes may comprise at least one of: determining a workflow sequence optimization; determining an opportunity window for a maintenance activity associated with the one or more cells; determining a self-optimizing network exclusion list; and determining a list of cells to be scheduled to operate with reduced energy requirement.

The performing may comprise: receiving, from the management system, a request for a workflow sequence based on the one or more priority values associated with the respective one or more cells; determining the workflow sequence based on the request and the information indicating the one or more priority values; and sending, to the management system, the determined workflow sequence.

The performing may comprise: determining at least one cell to be included in the self-optimizing network exclusion list based on the information indicating the one or more priority values; and sending, to the management system, the self-optimizing network exclusion list, wherein the exclusion list comprises the determined at least one cell.

The determining may comprise: determining, for each cell of the one or more cells, a respective priority value; comparing the determined priority value against a threshold; and including the cell in the self-optimizing network exclusion list if the comparison indicates that the priority value associated with the cell is above the threshold.

The performing may comprise: determining the list of cells for energy saving scheduling based on the information indicating the one or more priority values; and sending, to the management system, the determined list of cells for energy saving scheduling.

The determining may comprise: determining, for each cell of the one or more cells, a respective priority value; comparing the determined priority value against a threshold; and including the cell in the list of cells for energy saving scheduling if the comparison indicates that the priority value is below the threshold.

The performing may comprise: receiving, from the management system, a request for an opportunity window for a maintenance activity associated with the one or more cells; determining the opportunity window for the maintenance activity associated with the one or more cells based on the information indicating the one or more priority values; and at the start of the determined opportunity window, sending, to the management system, a notification for causing the maintenance activity to be performed.

According to an aspect, there is provided a method comprising: receiving, from an automation function, information indicating one or more priority values associated with a respective one or more cells; and sending, to a network optimization function, the information indicating the one or more priority values associated with the respective one or more cells.

The method may comprise: sending, to the network optimization function, a request for a workflow sequence based on the one or more priority values associated with the respective one or more cells; receiving, from the network optimization function, the workflow sequence; and causing one or more operations to be performed based on the received workflow sequence.

The method may comprise: receiving, from the network optimization function, a self-optimizing network exclusion list, wherein the exclusion list comprises at least one of the one or more cells; and causing one or more self-optimizing network operations to be performed for cells other than the cells included in the self-optimizing network exclusion list.

The method may comprise: receiving, from the network optimization function, a list of cells to be scheduled to operate with reduced energy requirement; and causing cells included in the list of cells to operate with reduced energy requirement.

The method may comprise: receiving information indicating that a maintenance activity is required for the one or more cells; responsive to receiving the information indicating that the maintenance activity is required for the one or more cells, sending, to the network optimization function, a request for an opportunity window for performing the maintenance activity associated with the one or more cells; at the start of the opportunity window, receiving, from the network optimization function, a notification for causing the maintenance activity to be performed; and causing the maintenance activity to be performed in response to receiving the notification.

According to an aspect, there is provided a method comprising: receiving an input comprising information indicating a strategy for cell prioritization for one or more cells; determining a priority value for each of the one or more cells based on the defined strategy; and sending, to a management system, information indicating the determined priority values associated with the one or more cells.

The method may comprise: periodically performing the determining and the sending, wherein the received input further comprises information indicating a periodicity for performing the determining and the sending; and/or performing the determining and the sending in response to detecting a trigger event.

The method may comprise: obtaining, from an analytics function and based on the information indicating the strategy for cell prioritization, analytics information associated with the one or more cells.

The analytics information associated with the one or more cells may comprise one or more of: predicted traffic information for the one or more cells; and predicted revenue information associated with the one or more cells.

The information indicating the one or more priority values may define a relative priority of the one or more cells.

The information indicating the one or more priority values may comprise a cell operational priority index.

The cell operational priority index may comprise a first set of bits indicating a strategy for cell prioritization and a second set of bits indicating a priority value; or the cell operational priority index may be a tuple of two values, wherein a first value indicates the strategy for cell prioritization and a second value indicates a priority value.

According to an aspect, there is provided a computer readable medium comprising program instructions for causing an apparatus to perform at least the following: receiving, from a management system, information indicating one or more priority values associated with a respective one or more cells; and performing one or more network optimization processes based on the received information indicating the one or more priority values associated with the respective one or more cells.

The one or more network optimization processes may comprise at least one of: determining a workflow sequence optimization; determining an opportunity window for a maintenance activity associated with the one or more cells; determining a self-optimizing network exclusion list; and determining a list of cells to be scheduled to operate with reduced energy requirement.

The performing may comprise: receiving, from the management system, a request for a workflow sequence based on the one or more priority values associated with the respective one or more cells; determining the workflow sequence based on the request and the information indicating the one or more priority values; and sending, to the management system, the determined workflow sequence.

The performing may comprise: determining at least one cell to be included in the self-optimizing network exclusion list based on the information indicating the one or more priority values; and sending, to the management system, the self-optimizing network exclusion list, wherein the exclusion list comprises the determined at least one cell.

The determining may comprise: determining, for each cell of the one or more cells, a respective priority value; comparing the determined priority value against a threshold; and including the cell in the self-optimizing network exclusion list if the comparison indicates that the priority value associated with the cell is above the threshold.

The performing may comprise: determining the list of cells for energy saving scheduling based on the information indicating the one or more priority values; and sending, to the management system, the determined list of cells for energy saving scheduling.

The determining may comprise: determining, for each cell of the one or more cells, a respective priority value; comparing the determined priority value against a threshold; and including the cell in the list of cells for energy saving scheduling if the comparison indicates that the priority value is below the threshold.

The performing may comprise: receiving, from the management system, a request for an opportunity window for a maintenance activity associated with the one or more cells; determining the opportunity window for the maintenance activity associated with the one or more cells based on the information indicating the one or more priority values; and at the start of the determined opportunity window, sending, to the management system, a notification for causing the maintenance activity to be performed.

According to an aspect, there is provided a computer readable medium comprising program instructions for causing an apparatus to perform at least the following: receiving, from an automation function, information indicating one or more priority values associated with a respective one or more cells; and sending, to a network optimization function, the information indicating the one or more priority values associated with the respective one or more cells.

The instructions may be for causing the apparatus to perform: sending, to the network optimization function, a request for a workflow sequence based on the one or more priority values associated with the respective one or more cells; receiving, from the network optimization function, the workflow sequence; and causing one or more operations to be performed based on the received workflow sequence.

The instructions may be for causing the apparatus to perform: receiving, from the network optimization function, a self-optimizing network exclusion list, wherein the exclusion list comprises at least one of the one or more cells; and causing one or more self-optimizing network operations to be performed for cells other than the cells included in the self-optimizing network exclusion list.

The instructions may be for causing the apparatus to perform: receiving, from the network optimization function, a list of cells to be scheduled to operate with reduced energy requirement; and causing cells included in the list of cells to operate with reduced energy requirement.

The instructions may be for causing the apparatus to perform: receiving information indicating that a maintenance activity is required for the one or more cells; responsive to receiving the information indicating that the maintenance activity is required for the one or more cells, sending, to the network optimization function, a request for an opportunity window for performing the maintenance activity associated with the one or more cells; at the start of the opportunity window, receiving, from the network optimization function, a notification for causing the maintenance activity to be performed; and causing the maintenance activity to be performed in response to receiving the notification.

According to an aspect, there is provided a computer readable medium comprising program instructions for causing an apparatus to perform at least the following: receiving an input comprising information indicating a strategy for cell prioritization for one or more cells; determining a priority value for each of the one or more cells based on the defined strategy; and sending, to a management system, information indicating the determined priority values associated with the one or more cells.

The instructions may be for causing the apparatus to perform: periodically performing the determining and the sending, wherein the received input further comprises information indicating a periodicity for performing the determining and the sending; and/or performing the determining and the sending in response to detecting a trigger event.

The instructions may be for causing the apparatus to perform: obtaining, from an analytics function and based on the information indicating the strategy for cell prioritization, analytics information associated with the one or more cells.

The analytics information associated with the one or more cells may comprise one or more of: predicted traffic information for the one or more cells; and predicted revenue information associated with the one or more cells.

The information indicating the one or more priority values may define a relative priority of the one or more cells.

The information indicating the one or more priority values may comprise a cell operational priority index.

The cell operational priority index may comprise a first set of bits indicating a strategy for cell prioritization and a second set of bits indicating a priority value; or the cell operational priority index may be a tuple of two values, wherein a first value indicates the strategy for cell prioritization and a second value indicates a priority value.

According to an aspect, there is provided a non-transitory computer readable medium comprising program instructions for causing an apparatus to perform at least the method according to any of the preceding aspects.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a representation of a network system according to some example embodiments;

FIG. 2 shows a representation of a control apparatus according to some example embodiments;

FIG. 3 shows a representation of an apparatus according to some example embodiments;

FIG. 4 shows methods according to some examples;

FIG. 5 shows an illustration of a system including a NOWOA;

FIG. 6 shows an illustration of a system including an NAAP;

FIG. 7 shows an example end-to-end message sequence for NOWOA assisted operational workflow optimization;

FIG. 8 shows an example use of COPI for network optimization;

FIG. 9 shows an example for utilizing the COPI value to prioritize field actions; and

FIG. 10 shows an example scenario when multiple sites report performance affecting alarms simultaneously.

### DETAILED DESCRIPTION

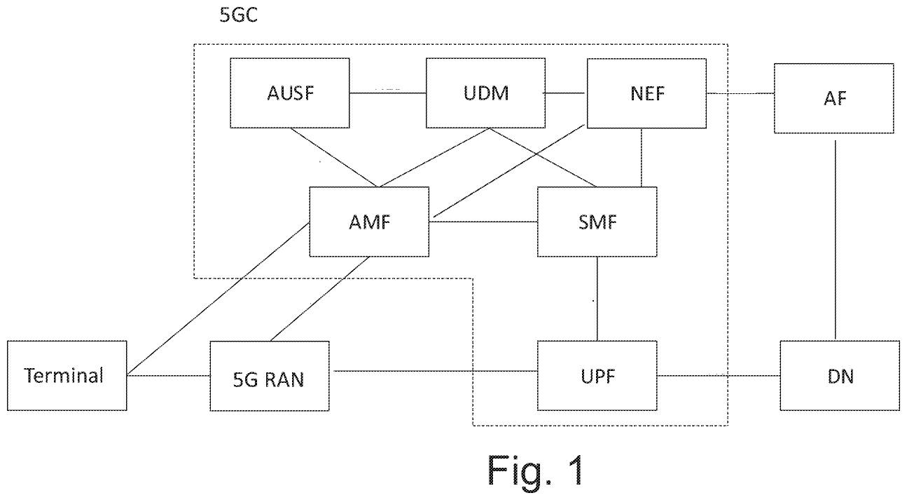

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS). The 5GS may be comprised by a terminal or user equipment (UE), a 5G radio access network (5GRAN) or next generation radio access network (NG-RAN), a 5G core network (5GC), one or more application function (AF) and one or more data networks (DN).

The 5G-RAN may comprise one or more gNodeB (GNB) or one or more gNodeB (GNB) distributed unit functions connected to one or more gNodeB (GNB) centralized unit functions. The 5GC may comprise the following entities: Network Slice Selection Function (NSSF); Network Exposure Function; Network Repository Function (NRF); Policy Control Function (PCF); Unified Data Management (UDM); Application Function (AF); Authentication Server Function (AUSF); an Access and Mobility Management Function (AMF); and Session Management Function (SMF).

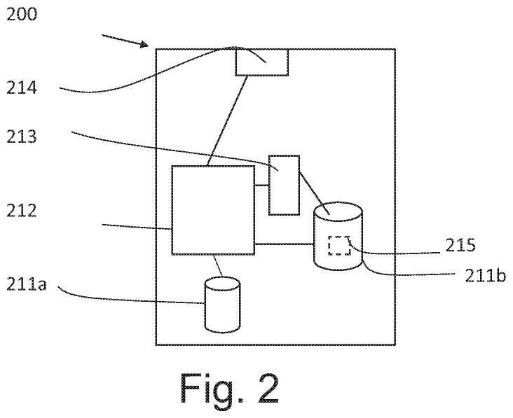

FIG. 2 illustrates an example of a control apparatus 200 for controlling a function of the 5GRAN or the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5GRAN or the 5GC. In some embodiments, each function of the 5GRAN or the 5GC comprises a control apparatus 200. In alternative embodiments, two or more functions of the 5GRAN or the 5GC may share a control apparatus.

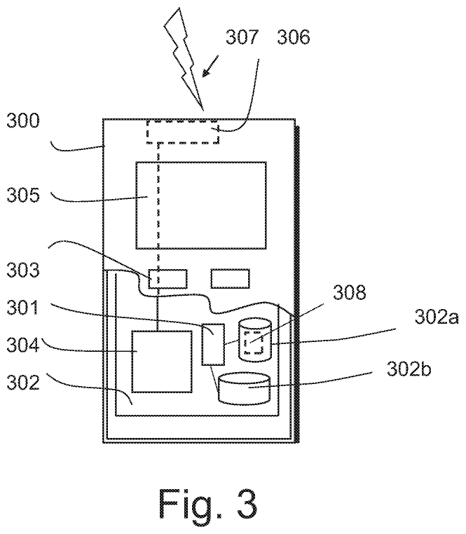

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (IoT) type communication device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus can be provided on an appropriate circuit board and/or in chipsets. This feature is denoted by reference 304. The device may optionally have a user interface such as key pad 305, touch sensitive screen or pad, combinations thereof or the like. Optionally one or more of a display, a speaker and a microphone may be provided depending on the type of the device.

In many wireless network operational scenarios, it may be necessary or beneficial to prioritize one site/cell over the other. For example, in a scenario when multiple sites/cells report performance affecting alarms simultaneously, prioritization can help decide the urgency levels to restores respective sites; or in a scenario during a natural calamity, where all sites/cells in an area are down, the sites can be replaced with nomadic nodes based on a priority of the downed sites/cells. A further example may be for performing centralized self-optimizing network (C-SON) optimization, for e.g., MLB, there may be multiple neighbours to which offloading can happen. Any increase in traffic may impact performance of whole cell. C-SON can consider priorities of neighbour so that extra traffic is offloaded to less priority sites.

Some mechanisms to identify site/cell priorities may be manual, with classification criteria based on the operator's understanding of the network. For example, an operator may consider traffic generated from each site/cell as a criterion for prioritisation and may consider the average daily traffic ignoring the fact that traffic distribution may not be the same throughout the day. The prioritisations computed by these service oriented architecture (SOA) solutions may not be as frequently updated as needed, owing to too much manual analysis/calculations.

Some methods for triggering software upgrades (or any planned outages) on multiple sites/cells may be performed during maintenance windows. The trigger for any such operation may be manual, and in 5G and beyond, there may be a need for automation to cater to the volume of network elements and additional complexity.

For example, in 5G, multiple network slices can be defined, including consumer specific slices, with different availability requirements. Some methods for planned outages in such scenarios may not consider the network slice related requirements. Radio network slices can be shared between multiple consumer specific slices. Some operational mechanisms may not consider any prioritizations related to such shared network slices.

Some mechanisms may be semi-automated, and hence still not capable of frequent and dynamic adaptation for runtime network conditions. Static priorities may degenerate and may not make use of the available dynamic information, as such, they may not be correct all the time for all scenarios

Some SON optimization algorithms may not consider operational priorities of cells, and hence may not minimize known/unknown and expected/unexpected negative actions on high priority traffic, may not execute orchestration actions according to the priority to maximize positive outcomes (e.g., cell availability), and may not determine best window of opportunity for planned maintenance activities that require an outage.

A related challenge is also that existing standards specifications do not have provisions to allow for configuring sites/cells operational priority level. A solution to allow for automating the prioritization of sites/cells should also support means to configure the sites/cells according to the computed prioritizations

Some embodiments may address one or more of the abovementioned challenges.

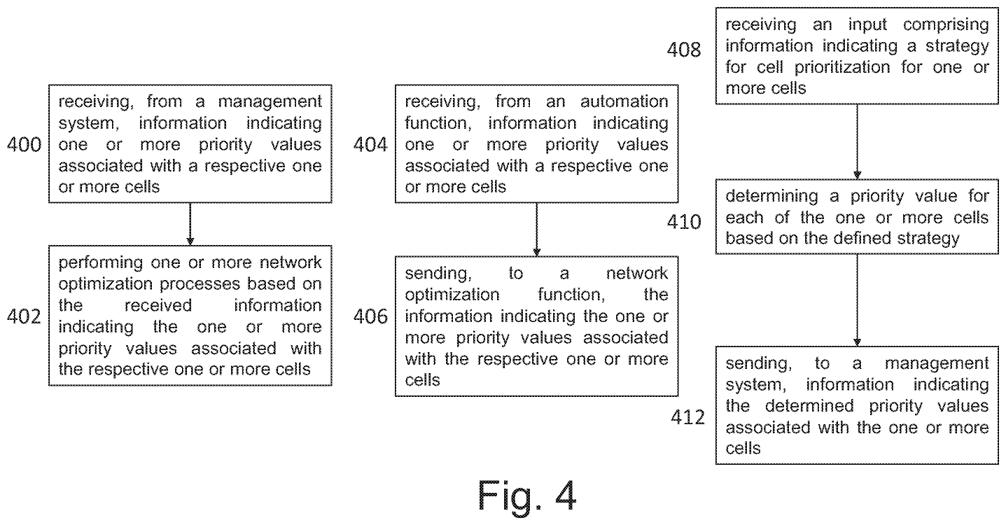

Reference is made to FIG. 4, which shows methods according to some examples. At step 400, a method comprises receiving, from a management system, information indicating one or more priority values associated with a respective one or more cells.

At step 402, the method comprises performing one or more network optimization processes based on the received information indicating the one or more priority values associated with the respective one or more cells.

Steps 400 and 402 may in some examples be performed by a network optimization function, such as a NOWOA or NAPP.

At step 404, a method comprises receiving, from an automation function, information indicating one or more priority values associated with a respective one or more cells.

At step 406, the method comprises sending, to a network optimization function, the information indicating the one or more priority values associated with the respective one or more cells.

Steps 404 and 406 may in some examples be performed by a network management system and/or SON.

At step 408, a method comprises receiving an input comprising information indicating a strategy for cell prioritization for one or more cells.

At step 410, the method comprises determining a priority value for each of the one or more cells based on the defined strategy.

At step 412, the method comprises sending, to a management system, information indicating the determined priority values associated with the one or more cells.

Steps 408 to 412 may in some examples be performed by an automation function.

Some examples may provide solutions for orchestrating network operations and automations based on a cell/site prioritization parameter, which can be updated during runtime based on current or predicted network characteristics. Some examples provide a cell/site operational priority Index (COPI) as a parameter that defines the relative priorities of the cells and sites and the use of the COPI for optimizing operational workflows. COPI can in some examples be used by C-SON to fine-tune the network optimization actions, e.g., to include critical sites in the SON exclusion list (a list of cells that are excluded from SON optimizations but considered for analysis).

In some examples, a 3GPP management system may enable an authorized consumer to:
request for a computation of an operational priority level of a cell based on different operational strategies, like traffic, area, number, and type of customers served by the cell or its resource usage;
be informed about the operational priority level of a cell; and
request for a prioritization of operational actions on a set of cells, the prioritization considering the priority level of the involved cells.

Accordingly, in some examples the COPI may be introduced as a configurable attribute of the cell managed objects. The index may be configurable and/or utilized by different automation functions. Thus, in some examples, the COPI may be introduced for the one or more objects GNBDU, NRCellCU, NRCellDU functions or other related functions.

In some examples, an analytics function/service may compute and configure the COPI for one or more cells based on specific strategies; and/or an analytics function/service may compute and configure an operational workflow for one or more cells prioritized according to a given strategy.

In some examples, the COPI is a configurable parameter for each cell or site. The COPI may describe the relative priorities of a cell/site within the network. The priority may be based on a network operator's importance gradient.

The COPI may be computed and set by the operator, or it may be computed and set by an automation function based on some operator-defined strategy. Example strategies include, but are not limited to:
Prioritizing cells/sites based on traffic serviced by different cells;
Prioritizing cells/sites based on number of roaming customers;
Prioritizing cells/sites based on area serviced by the cell, say, hospitals, schools, etc.; and
Prioritizing cells/sites based on resource utilizations for specific network slices.

In some examples, a network optimization function may be provided. In some examples, the network optimization function may comprise a Network Operational Workflow Optimization Application (NOWOA). The NOWOA may use the COPI to manage and optimize workflow actions depending on the priorities of the cells and sites for which operational actions are needed.

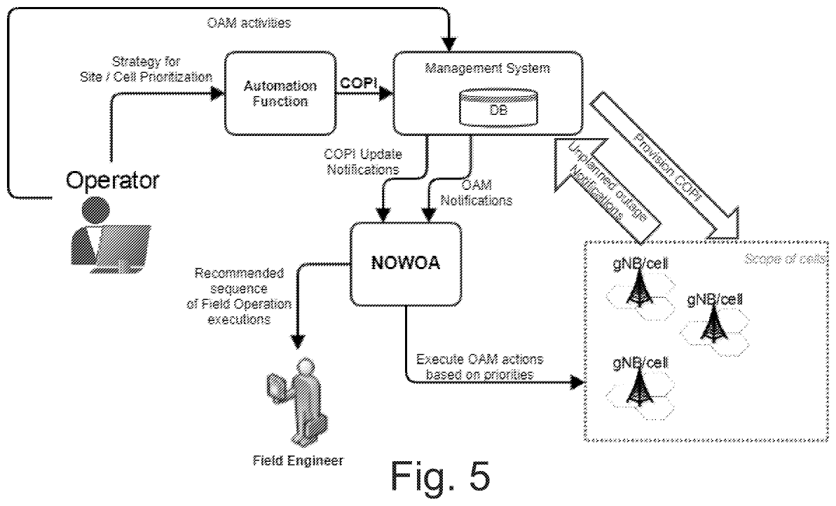

Reference is made to FIG. 5, which shows an illustration of a system including a NOWOA.

As illustrated by FIG. 5, the NOWOA may receive as input the relative priorities of the cells/sites, for example as COPI Update Notifications. The NOWOA may use the input relative priorities to compute the decisions for different Network Operation use cases.

In some examples, the NOWOA may derive recommendations for subsequent operational actions and provide an output, such as a recommended sequence of operations, towards a field engineer for each of the applicable Network Operation scenarios.

For example:
The NOWOA may recommend a field engineer to consider Cell A before Cell B for corrective actions based on a higher COPI associated with Cell A;
During a natural calamity, when all sites in an area are down, NOWOA may utilize COPI for recommending priority areas for temporary nomadic nodes deployment;
NOWOA can schedule software upgrade for multiple sites based on COPI.

In some examples, the network operator may define a strategy to prioritize cell/sites based on traffic. In such examples, the COPI value may change according to measured/predicted traffic conditions in different sites. Accordingly, in some examples, when traffic in some cells is low, the COPI will also be a lower value for those cells. This may provide an opportunity for planned site outages.

The NOWOA may monitor the changing COPI value and may determine an opportunity window for performing a maintenance activity associated with one or more cells. The opportunity may be a time period during which a maintenance activity may be performed. For example, the NOWOA may, based on the COPI value, trigger a maintenance activity, such as performing software upgrades or outage causing parameter changes at one or more sites/cells, when the NOWOA determines that the COPI value is low for the one or more sites/cells.

In some examples, the network optimization function may comprise a Network Automation Action Prioritization (NAAP). The NAAP may use the COPI to manage and optimize actions derived by Network Automation Functions depending on the priorities of the cells and sites on which Network Automation Functions desires to take actions.

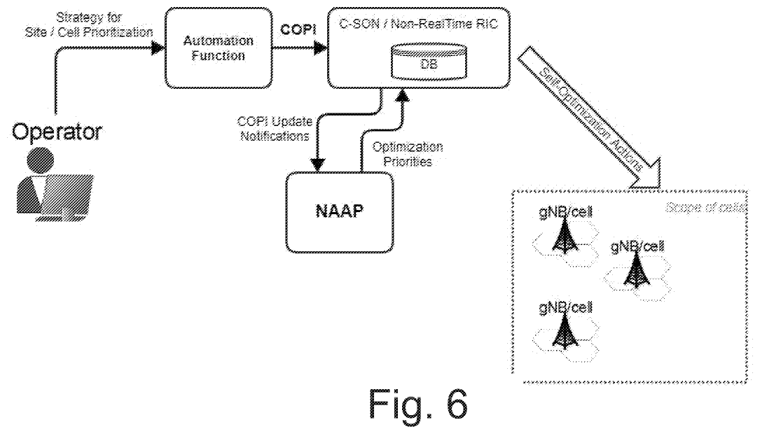

Reference is made to FIG. 6, which shows an illustration of a system including an NAAP.

As illustrated by FIG. 6, in some examples the NAAP may receive as input the relative priorities of the cells/sites, for example COPI Update Notifications. The NAAP may further receive characteristics of the Network Automation Functions (NAFs). The NAAP may then use the received priorities and characteristics to compute the decisions for different NAFs or Network Automation use cases.

For example, if a load balancing optimization requires to increase the coverage of 3 neighboring cells, NAAP may provide an output which restricts one of the 3 cells from increasing coverage. As another example, the NAAP may provide an output to change the SON exclusion list based on current or predicted value of COPI. In some examples, the NAAP may use the COPI evaluate whether cells/sites can be shut down for energy saving, or to propose nomadic node deployment for additional capacity requirements in higher priority sites.

In some examples, the NAAP may be implemented by each NAF, for example the NAAP may be implemented within the NAF. In some examples, there may be one NAAP for a set of NAFs, or one NAAP for each NAF.

In some examples, the COPI may associate a certain operational priority for each site/cell based on strategy defined by the operator. An example structure of the COPI is defined in Table 1 below. Table 2 shows an example definition of the COPI attribute.

TABLE 1
COPI parameter added to the GNBDUFunction IOC

| | | isRead- | | | |
|---|---|---|---|---|---|
| Attribute name | S | able | isWritable | isInvariant | isNotifyable |
| gNBDUId | M | T | T | F | T |
| gNBDUName | O | T | T | F | T |
| gNBId | M | T | F | F | T |
| gNBIdLength | M | T | T | F | T |
| rimRSReportConf | O | T | F | T | T |
| COPI | CM | T | T | F | T |

TABLE 2
COPI parameter description

| Name | Definition | Range, Step |
|---|---|---|
| COPI | This attribute defines cell operational priority index | 0-9, 1 |

The COPI value can in some examples be dynamically updated either by the operator or by an automation function. The COPI value may be configured in gNB.

In some examples, a cell level priority index is defined. The index may be a single value indicating the priority for the current running strategy defined by the operator.

Some example implementations may combine both the strategy and context into the COPI value. For example, there may be one COPI value where different bits indicate two perspectives, e.g. using a 32 bit I/O string for COPI, where the first 16 bit indicate the different strategy (or context id), while the rest of the bits indicate the current COPI value. Alternatively, the COPI may be a tuple of two values where the first value indicates the different strategy (or context id), and the second value indicates the current COPI value.

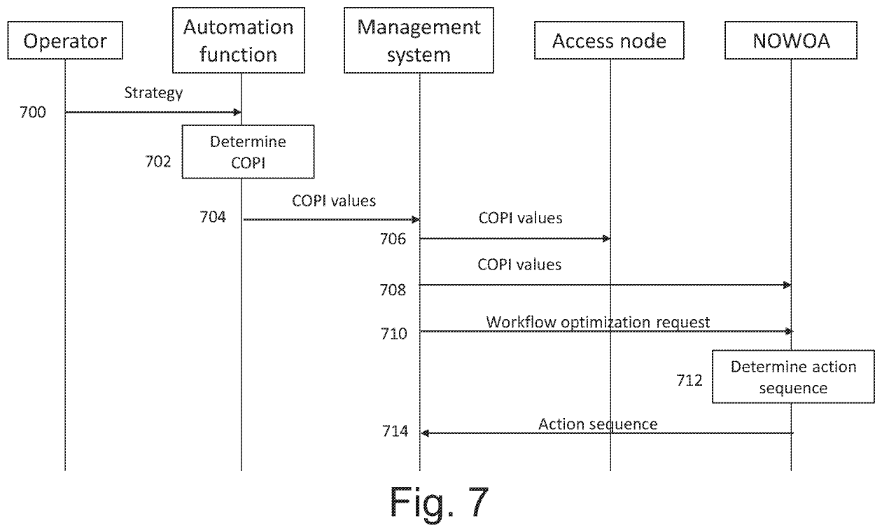

Reference is made to FIG. 7, which shows an example end-to-end message sequence for NOWOA assisted operational workflow optimization.

At step 700, the network operator defines a strategy for cell/site prioritization, and provides an indication of the strategy to an automation function. In some examples, a strategy may be a rule based formula. The strategy may be input by methods such as but not limited to selection via a menu, json file etc. The strategy may be defined for a given scope of cells/sites. As explained previously, examples of strategies include, but are not limited to:
Prioritizing cells/sites based on traffic serviced by different cells;
Prioritizing cells/sites based on number of roaming customers;
Prioritizing cells/sites based on area serviced by the cell, such as hospitals, schools, etc.; and
Prioritizing cells/sites based on resource utilizations for specific network slices.

At step 702, the automation function determines COPI values based on the indication received at 700.

At step 704, the automation function sends, to the management system, the determined COPI values. The COPI values may be sent based on the scope of the defined strategy. For example, the COPI values may be sent to a management system that manages access nodes that are within the scope of the defined strategy. The management system may for example be a network management system or a self-organizing network.

At step 706, the management system sends the COPI values received at step 706 to one or more access nodes. The COPI values may be sent based on the scope of the defined strategy. For example, the COPI values may be sent to the access nodes that are within the scope of the defined strategy.

At step 708, the management system sends, to the NOWOA, information about the COPI values received at step 704.

Steps 702 to 708 may be repeated periodically. The periodicity may be controlled by the network operator. Additionally or alternatively, steps 702 to 708 may be triggered by an event, such as but not limited to occurrence of an alarm, a relative change in traffic pattern of the network (for example if the change is above a certain threshold), a relative change in priority users in the cell, or a manual trigger from the network operator.

At step 710, the management system sends a request for workflow optimization to the NOWOA. In some examples, the request may be sent in response to the management system determining that a new software package is available for deployment, a request from a user or C-SON for a parameter change that involves outage of one or more cells/sites, or when multiple cell/cite outages are detected.

At step 712, the NOWOA, in response to the request, determines a sequence of actions based on the COPI values received at 708.

At step 714, the NOWOA sends, to the management system, the determined sequence of actions.

The management system may then cause the sequence of actions to be performed. For example, the management system may instruct one or more other network entities to perform one or more actions, such as but not limited to restarting a cell/site, providing a change in parameter, or performing a software upgrade.

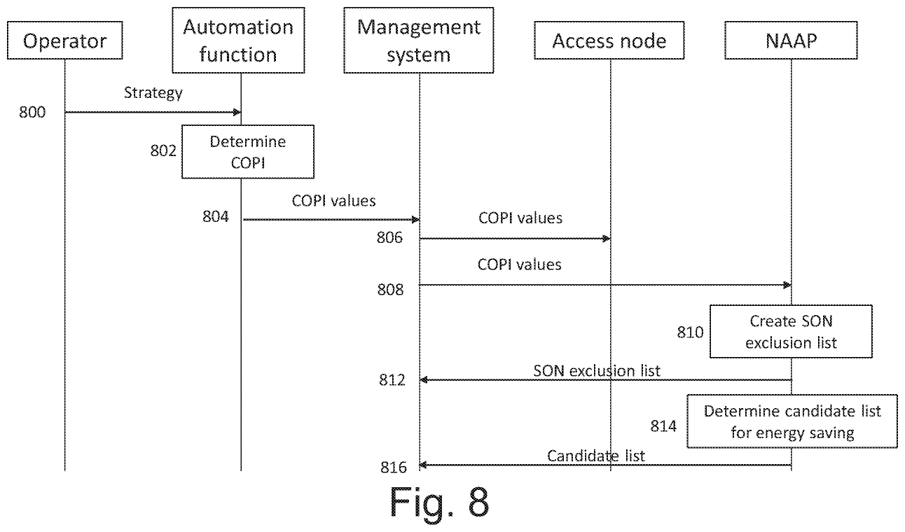

Reference is made to FIG. 8, which shows an example use of COPI for network optimization.

At step 800, the network operator defines a strategy for cell/site prioritization and provides an indication of the strategy to an automation function. The strategy may be defined for a given scope of cells/sites. As explained previously, examples of strategies include, but are not limited to:
Prioritizing cells/sites based on traffic serviced by different cells;
Prioritizing cells/sites based on number of roaming customers;
Prioritizing cells/sites based on area serviced by the cell, such as hospitals, schools, etc.; and
Prioritizing cells/sites based on resource utilizations for specific network slices.

At step 802, the automation function determines COPI values based on the indication received at 800.

At step 804, the automation function sends, to the management system, the determined COPI values. The COPI values may be sent based on the scope of the defined strategy. For example, the COPI values may be sent to a management system that manages access nodes that are within the scope of the defined strategy. The management system may for example be a network management system or a self-organizing network.

At step 806, the management system sends the COPI values received at step 806 to one or more access nodes. The COPI values may be sent based on the scope of the defined strategy.

For example, the COPI values may be sent to the access nodes that are within the scope of the defined strategy.

At step 808, the management system sends, to the NAAP, the COPI values received at step 804.

Steps 802 to 808 may be repeated periodically. The periodicity may be controlled by the network operator. Additionally or alternatively, steps 802 to 808 may be triggered by an event, such as but not limited to occurrence of an alarm, a relative change in traffic pattern of the network (for example if the change is above a certain threshold), a relative change in priority users in the cell, or a manual trigger from the network operator.

The NAAP may then perform one or more actions utilising the COPI values, some of which are illustrated in steps 810 to 816. Steps 810 to 812 relate to the creation of an SON exclusion list, and steps 814 to 816 relate to energy saving operations. It should be understood that steps 810 and 812 may be performed separately to steps 814 and 816 in some examples.

At step 810, the NAAP creates a SON exclusion list based on the received COPI values. For example, the NAAP may include cells/sites with a COPI value above or below a threshold in the SON exclusion list.

At step 812, the NAAP sends the SON exclusion list to the management system.

The management system may then cause one or more self-optimizing network operations to be performed for cells other than the cells included in the self-optimizing network exclusion list. Examples of self-optimizing network operations include, but are not limited to, performing load balancing operations, mobility robustness optimization (MRO), and cell outage compensation.

As an example, in the case of load balancing operations, traffic may need to be offloaded from a congested cell to neighbouring cells. However, this may result in a loss of quality, and thus there may be a trade-off between network capacity and quality. By utilizing dynamic COPI values as shown in steps 810 and 812 of FIG. 8, the NAAP may restrict certain sets of cells from certain load balancing related optimizations, thereby ensuring that certain quality requirements are not compromised.

At step 814, the NAAP determines a candidate list of cells/sites for energy saving operations based on the COPI values. For example, the NAAP may include cells/sites with a COPI value above or below a threshold in the candidate list.

At step 816, the NAAP sends the candidate list to the SON.

As an example, in the case of energy saving operations, certain cells/sites may be scheduled to operate with reduced energy requirement (e.g. turn off during certain periods, or operate with lower transmission power). However, this may come with a trade-off of cell/site availability or coverage. By utilizing dynamic COPI values as shown in steps 814 and 816 of FIG. 8, the NAAP may provide an input to the SON to only consider low priority cells/sites for energy saving schedules, thereby ensuring that high priority cells/sites are not disrupted.

As explained previously, the network operator can in some examples define different strategies for assigning priorities to different cells. The NOWOA/NAPP may have a periodic re-evaluation of the operational priorities for each cell.

For example, a strategy may be defined as “Utilize the predicted traffic as criteria for defining dynamic priorities”.

This strategy may cause an analytics function to predict traffic for all cells and provide the predicted traffic to the automation function. Depending on the predicted traffic, the automation function may determine relative priority indices and send the relative priority indices to the NOWOA/NAPP for use as described above, such as for operational workflow optimization

Another example strategy may be “Utilize the total revenue as a criteria for defining dynamic priorities”.

This strategy may cause an analytics function to predict the total revenue for all the cells in the given scope defined by the strategy. For example, the revenue prediction can be based on historic data for cost-per-bit, which may be computed considering many parameters such as traffic patterns, priority users camped on the cell, active user patterns, etc. The revenue prediction may be sent to the automation function.

Depending on the revenue prediction, the automation function may determine relative priority indices and send the relative priority indices to the NOWOA/NAPP for subsequent use as described above.

Another example strategy may be a Network slice traffic-based prioritization strategy.

For example, depending on sites catering to network slices demanding high availability, and the traffic patterns on these sites, dynamic priority computations can be done by the automation function.

For example, cell A and B may both cater to a network slice X which requires 99.9999% availability, as well as slice Y which has relatively lower availability requirements. If cell A has relatively lower traffic in slice X, than cell B's traffic in slice X between 6 AM-9 AM, then, between this period, cell B has a higher priority than cell A, even if, the total traffic in cell A is more than cell B.

If this changes after 9 AM, cell priority allocations may also change. That is to say, the priority allocation may change dynamically according to traffic pattern in slice X.

Thus, in some examples, the NOWOA/NAPP may make decisions based on a current priority allocation, which can change with time, depending on defined strategy.

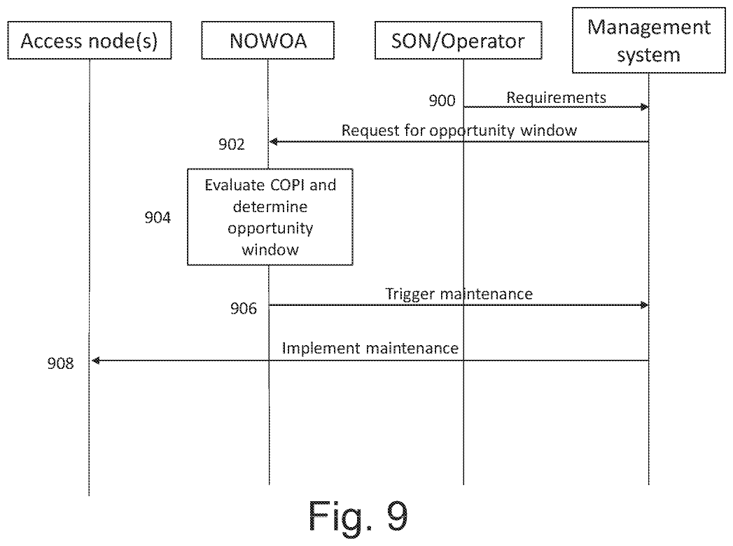

Reference is made to FIG. 9, which shows an example for utilizing the COPI value to prioritize field actions. There may be scenarios where site outages need to be planned for certain radio parameter changes, or SW upgrades, etc. In such cases, it may be important to determine the best window of opportunity for the planned outage.

In the example of FIG. 9, the network operator or SON may need to plan radio parameter changes or software upgrades for a set of cells.

At 900, the operator/SON sends information indicating one or more requirements to the management service. The requirements may for example be planned outage requirements, such as indicating the set of cells for which software upgrades are required.

At 902, the management service sends a request to the NOWOA. The request may be for an opportunity window to implement the upgrades.

At 904, the NOWOA monitors the COPI value of one or more sites based on the received request and determines an opportunity window in which the maintenance activity may be implemented.

At 906, the NOWOA sends a trigger to the management service for implementing the maintenance activity.

At 910, the management service sends, to the set of cells, information for implementing the maintenance activity, for example for implementing the software upgrades.

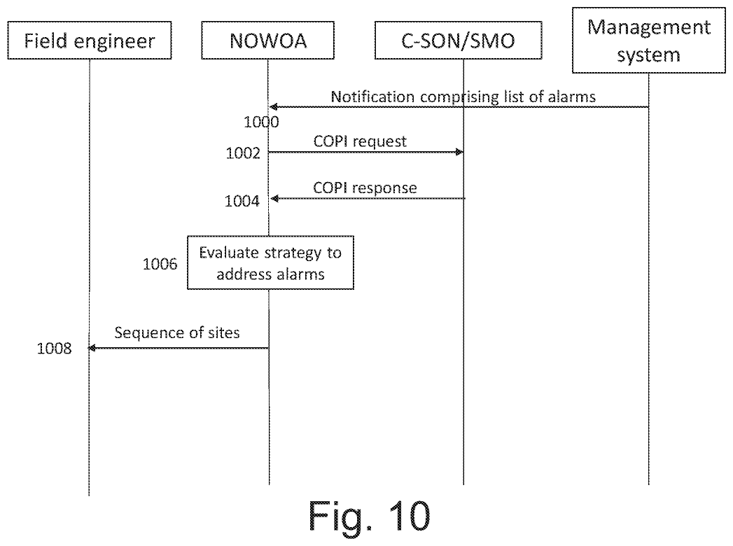

FIG. 10 shows an example scenario when multiple sites report performance affecting alarms simultaneously.

At 1000, the management service sends, to the NOWOA/NAPP a notification comprising a list of cells with alarms.

At 1002, the NOWOA/NAPP sends, to the C-SON/SMO, a request for cell priority information for the list of cells.

At 1004, based on the request, the C-SON/SMO sends a response comprising COPI values for the cells comprised in the list of cells to the NOWOA/NAPP.

At 1006 the NOWOA/NAPP evaluates a strategy for addressing the alarms based on the COPI values. For example, the NOWOA/NAPP may determine a sequence of cells/sites for the field engineer to fix based on the COPI values.

At 1008, the NOWOA/NAPP provides an output to field engineer based on the evaluated strategy. The output may comprise information indicating a sequence of actions to take to address the alarms. For example, the output may comprise actions in a sequence that prioritizes the highest priority cells.

The field engineer may then act according to the sequence provided by NOWOA/NAPP.

Another possible scenario for using dynamic COPI to plan for operational workflows may be, for example, during a natural calamity, when all sites in an area are down. In such scenarios, the NOWOA/NAPP can provide an output to the Network automation function, which can identify locations and schedule temporary nomadic nodes deployment.

While reference has been made above to a NOWOA and/or NAPP, it should be understood that the functions of the NOWOA and/or NAPP may be implemented by any suitable network optimization function, and not limited to a NOWOA and/or NAPP. That is to say, in some examples, the previously described functions performed by the NOWOA/NAPP may be performed by a network optimization function.

The management system may have the capability to enable an authorized consumer to request for a computation of an operational priority level of a cell based on different operational strategies, like traffic, area, number and type of customers served by the cell or its resource usage.

The management system may have the capability to enable an authorized consumer to be informed about the operational priority level of a cell.

The management system may have the capability to enable an authorized consumer to request for a prioritization of operational actions on a set of cells, the prioritization considering the priority level of the involved cells.

Moreover to support these requirements, the Cell Operational Priority Index may be a configurable attribute of the cell managed objects, which Index may be configurable and/or utilized by different functions. Thereby the Cell Operational Priority Index may be introduced for either of GNBDU, NRCellCU, NRCellDU functions or other related functions.

Relatedly, an analytics function/service may compute and configure the COPI for one or more cells based on specific strategies; and/or compute and configure an operational workflow for one or more cells prioritized according to a given strategy.

In some examples, there is provided an apparatus comprising means for: receiving, from a management system, information indicating one or more priority values associated with a respective one or more cells; and performing one or more network optimization processes based on the received information indicating the one or more priority values associated with the respective one or more cells.

In some examples, there apparatus may comprise at least one processor and at least one memory including a computer program code, the at least one memory and computer program code configured to, with the at least one processor, cause the apparatus at least to: receive, from a management system, information indicating one or more priority values associated with a respective one or more cells; and perform one or more network optimization processes based on the received information indicating the one or more priority values associated with the respective one or more cells.

In some examples, there is provided an apparatus comprising means for: receiving, from an automation function, information indicating one or more priority values associated with a respective one or more cells; and sending, to a network optimization function, the information indicating the one or more priority values associated with the respective one or more cells.

In some examples, there apparatus may comprise at least one processor and at least one memory including a computer program code, the at least one memory and computer program code configured to, with the at least one processor, cause the apparatus at least to: receive, from an automation function, information indicating one or more priority values associated with a respective one or more cells; and send, to a network optimization function, the information indicating the one or more priority values associated with the respective one or more cells.

In some examples, there is provided an apparatus comprising means for: receiving an input comprising information indicating a strategy for cell prioritization for one or more cells; determining a priority value for each of the one or more cells based on the defined strategy; and sending, to a management system, information indicating the determined priority values associated with the one or more cells.

In some examples, there apparatus may comprise at least one processor and at least one memory including a computer program code, the at least one memory and computer program code configured to, with the at least one processor, cause the apparatus at least to: receive an input comprising information indicating a strategy for cell prioritization for one or more cells; determine a priority value for each of the one or more cells based on the defined strategy; and send, to a management system, information indicating the determined priority values associated with the one or more cells.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1. An apparatus comprising at least one processor and at least one memory including a computer program code, the at least one memory and computer program code configured to, with the at least one processor, cause the apparatus at least to perform:
receiving, from a management system, information indicating one or more priority values associated with a respective one or more cells; and
performing one or more network optimization processes based on the received information indicating the one or more priority values associated with the respective one or more cells.

2. The apparatus of claim 1, wherein the one or more network optimization processes comprise at least one of:
determining a workflow sequence optimization;
determining an opportunity window for a maintenance activity associated with the one or more cells;
determining a self-optimizing network exclusion list; and
determining a list of cells to be scheduled to operate with reduced energy requirement.

3. The apparatus of claim 2, wherein the performing comprises:
receiving, from the management system, a request for a workflow sequence based on the one or more priority values associated with the respective one or more cells;
determining the workflow sequence based on the request and the information indicating the one or more priority values; and
sending, to the management system, the determined workflow sequence.

4. The apparatus of claim 2, wherein the performing comprises:
determining at least one cell to be included in the self-optimizing network exclusion list based on the information indicating the one or more priority values; and
sending, to the management system, the self-optimizing network exclusion list, wherein the exclusion list comprises the determined at least one cell.

5. The apparatus of claim 4, wherein the determining comprises:
determining, for each cell of the one or more cells, a respective priority value;
comparing the determined priority value against a threshold; and
including the cell in the self-optimizing network exclusion list if the comparison indicates that the priority value associated with the cell is above the threshold.

6. The apparatus of claim 2, wherein the performing comprises:
determining the list of cells for energy saving scheduling based on the information indicating the one or more priority values; and
sending, to the management system, the determined list of cells for energy saving scheduling.

7. The apparatus of claim 6, wherein the determining comprises:
determining, for each cell of the one or more cells, a respective priority value;
comparing the determined priority value against a threshold; and
including the cell in the list of cells for energy saving scheduling if the comparison indicates that the priority value is below the threshold.

8. The apparatus of claim 2, wherein the performing comprises:
receiving, from the management system, a request for an opportunity window for a maintenance activity associated with the one or more cells;
determining the opportunity window for the maintenance activity associated with the one or more cells based on the information indicating the one or more priority values; and
at the start of the determined opportunity window, sending, to the management system, a notification for causing the maintenance activity to be performed.

9. An apparatus comprising at least one processor and at least one memory including a computer program code, the at least one memory and computer program code configured to, with the at least one processor, cause the apparatus at least to perform:
receiving, from an automation function, information indicating one or more priority values associated with a respective one or more cells; and
sending, to a network optimization function, the information indicating the one or more priority values associated with the respective one or more cells.

10. The apparatus of claim 9, wherein the at least one memory and computer program code are further configured to, with the at least one processor, cause the apparatus at least to perform:
sending, to the network optimization function, a request for a workflow sequence based on the one or more priority values associated with the respective one or more cells;
receiving, from the network optimization function, the workflow sequence; and
causing one or more operations to be performed based on the received workflow sequence.

11. The apparatus of claim 9, wherein the at least one memory and computer program code are further configured to, with the at least one processor, cause the apparatus at least to perform:
receiving, from the network optimization function, a self-optimizing network exclusion list, wherein the exclusion list comprises at least one of the one or more cells; and
causing one or more self-optimizing network operations to be performed for cells other than the cells included in the self-optimizing network exclusion list.

12. The apparatus of claim 9, wherein the at least one memory and computer program code are further configured to, with the at least one processor, cause the apparatus at least to perform:
receiving, from the network optimization function, a list of cells to be scheduled to operate with reduced energy requirement; and
causing cells included in the list of cells to operate with reduced energy requirement.

13. The apparatus of claim 9, wherein the at least one memory and computer program code are further configured to, with the at least one processor, cause the apparatus at least to perform:
receiving information indicating that a maintenance activity is required for the one or more cells;
responsive to receiving the information indicating that the maintenance activity is required for the one or more cells, sending, to the network optimization function, a request for an opportunity window for performing the maintenance activity associated with the one or more cells;
at the start of the opportunity window, receiving, from the network optimization function, a notification for causing the maintenance activity to be performed; and
causing the maintenance activity to be performed in response to receiving the notification.

14. An apparatus comprising at least one processor and at least one memory including a computer program code, the at least one memory and computer program code configured to, with the at least one processor, cause the apparatus at least to perform:
receiving an input comprising information indicating a strategy for cell prioritization for one or more cells;
determining a priority value for each of the one or more cells based on the defined strategy; and
sending, to a management system, information indicating the determined priority values associated with the one or more cells.

15. The apparatus of claim 14, wherein the at least one memory and computer program code are further configured to, with the at least one processor, cause the apparatus at least to perform:
periodically performing the determining and the sending, wherein the received input further comprises information indicating a periodicity for performing the determining and the sending; and/or
performing the determining and the sending in response to detecting a trigger event.

16. The apparatus of claim 14, wherein the at least one memory and computer program code are further configured to, with the at least one processor, cause the apparatus at least to perform:
obtaining, from an analytics function and based on the information indicating the strategy for cell prioritization, analytics information associated with the one or more cells.

17. The apparatus of claim 16, wherein the analytics information associated with the one or more cells comprises one or more of:
predicted traffic information for the one or more cells; and
predicted revenue information associated with the one or more cells.

18. The apparatus of claim 14, wherein the information indicating the one or more priority values defines a relative priority of the one or more cells.

19. The apparatus of claim 14, wherein the information indicating the one or more priority values comprises a cell operational priority index.

20. The apparatus of claim 19, wherein:
the cell operational priority index comprises a first set of bits indicating a strategy for cell prioritization and a second set of bits indicating a priority value; or
the cell operational priority index is a tuple of two values, wherein a first value indicates the strategy for cell prioritization and a second value indicates a priority value.

21-26. (canceled)
